(19) United States
(12) Patent Application Publication
(10) Pub. No.: US 2009/0147993 A1
(43) Pub. Date: Jun. 11, 2009

(54) HEAD-TRACKING SYSTEM

(75) Inventors: Jens Hoffmann, Mannheim (DE); Wolfgang Hess, Karlsbad (DE); Markus Dittmann, Viarlsnhe (DE)

Correspondence Address: THE ECLIPSE GROUP LLP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 12/168,587

(22) Filed: Jul. 7, 2008

(30) Foreign Application Priority Data
Jul. 6, 2007 (EP) EP 07 013 226.7

(51) Int. Cl. G06K 9/00

(52) U.S. Cl. 382/103

(57) ABSTRACT

A head-tracking system and a method for operating a head-tracking system in which a stationary reference point is detected are provided. A detector for detecting the position of a head is calibrated based on the detected stationary reference point. In one example implementation, the detection of the stationary reference point is used to determine the position of the head.

### RELATED APPLICATIONS

This application claims priority of European Patent Application Serial Number 07 013 226.7, filed on Jul. 6, 2007, titled HEAD-TRACKING SYSTEM AND METHOD FOR OPERATING A HEAD-TRACKING SYSTEM, which application is incorporated in its entirety by reference in this application.

### BACKGROUND OF THE INVENTION

1. Field of the Invention.

This invention relates generally to position and direction sensing systems, and more particularly, to systems for tracking position and direction of the head of a user.

2. Related Art.

An example of a head-tracking system is a head mounted display that includes a headset and a video display. The head-tracking system detects the direction that the head is facing. The direction is used to adjust a picture on the video display and/or a sound transmitted via the headset. As the head moves, the adjustments made by the head-tracking system create an impression of virtual reality.

Head-tracking systems use sensors to detect different types of movement of the head. For example, in one example head-tracking system, a gyroscope, or gyrosensor, detects a turning of the head around an upright axis along the longitudinal axis of the head, or in a horizontal plane of the head. Such a gyroscope detects the head motion by detecting an angular acceleration. As a gyroscope detects the angular acceleration, the zero point may drift over time. This drift reduces the precision of the direction determined by the head-tracking system.

There is a need for a head-tracking system that does not drift, or in which such drift may be compensated.

### SUMMARY

In view of the above, an example of a method for operating a head-tracking system is provided. In the method, a stationary reference point is detected, The position of a head equipped with the head-tracking system is determined based on the detected stationary reference point.

In another aspect of the invention, an example head-tracking system is provided. The head-tracking system includes a first detector for detecting a stationary reference point. A device is provided for determining the position of a head equipped with the head-tracking system based on the detected reference point.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic diagram that depicts a head in a three coordinate space to illustrate positional and directional parameters used in the description of example head-tracking systems.

FIG. 2 is another schematic diagram that depicts the head in FIG. 1 on an x-z plane to illustrate another parameter used in the description.

FIG. 3 is a block diagram of an example head-tracking system.

FIG. 4 is a perspective, schematic view of the head-tracking system in FIG. 3.

FIG. 5 is a block diagram of an example of a position-sensitive device used in the example head-tracking system of FIG. 3.

FIG. 6 is a schematic diagram illustrating operation of a sensor of an example of a position-sensitive device used in the head-tracking system in FIG. 3.

### DETAILED DESCRIPTION

In the following description of examples of various implementations of head-tracking systems, the following references are incorporated in their entirety into this application:
Makinen, “Position-Sensitive Devices and Sensor Systems for Optical Tracking and Displacement-Sensing Applications”, ISBN 1951-42-5770.
Jens Blauert, “Spatial Hearing—the psychophysics of human sound localization”, MIT Press, Cambridge Mass., 1983.

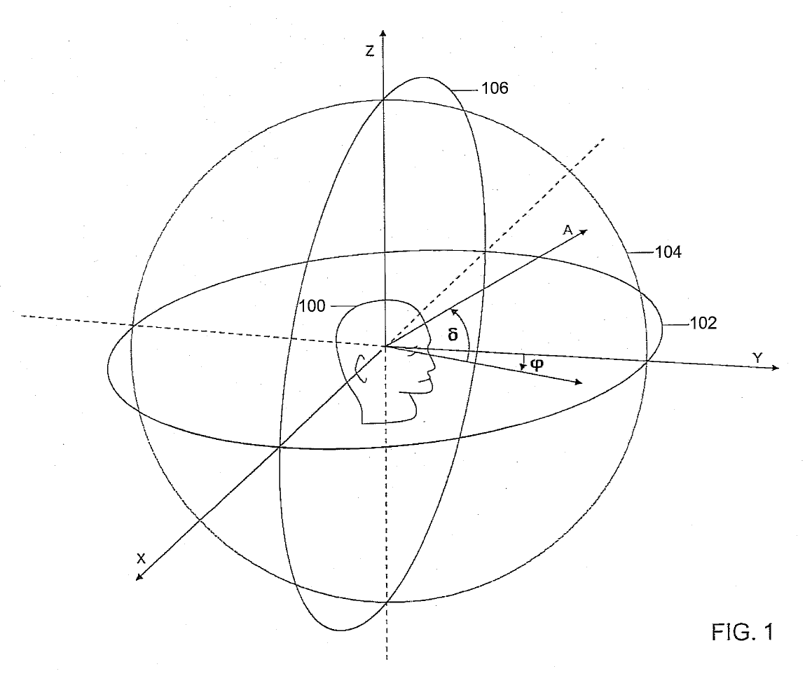

FIG. 1 is a schematic diagram that depicts a head 100 in a three coordinate space to illustrate positional and directional parameters used in the description of example head-tracking systems. Example head-tracking systems detect a direction in which a head of a subject of the system is facing and/or a position of the head. FIG. 1 shows the head 100 in an xyz coordinate system in which:
they-axis extends along the viewing direction of the head 100 when the head 100 is looking straight forward,
the z-axis corresponds to the longitudinal axis of the head 100 when the head 100 is held erect, or in a non-tilted position. The z-axis passes through the throat and the top of the head 100.
The x-axis is perpendicular to both the y-axis and the z-axis as shown in FIG. 1.

The x-axis and y-axis form a x-y plane, indicated by a circle 102 in FIG. 1. The x-y plane will be referred to in the description below as the horizontal plane. The x-axis and the z-axis form a x-z plane. The x-z plane is indicated by a circle 106 in FIG. 1 and will be referred to in the description below as the frontal plane. The y-axis and the z-axis form a y-z plane. The y-z plane is indicated by a circle 104 and will be referred to in the description below as the median plane.

The direction in which the head 100 viewing, or the viewing direction is indicated in the diagram in FIG. 1 by an arrow A. The viewing direction may be characterized by a yaw angle, a roll angle and a pitch angle, The yaw angle characterizes a turning of the head on the horizontal plane, which is a turning of the head around the z-axis as shown in FIG. 1. The yaw angle is indicated by φ in FIG. 1.

The pitch angle characterizes a “nodding” motion, or a turning of the head in the median plane. The pitch angle is indicated by δ in FIG. 1 and may also be referred to as the elevation angle.

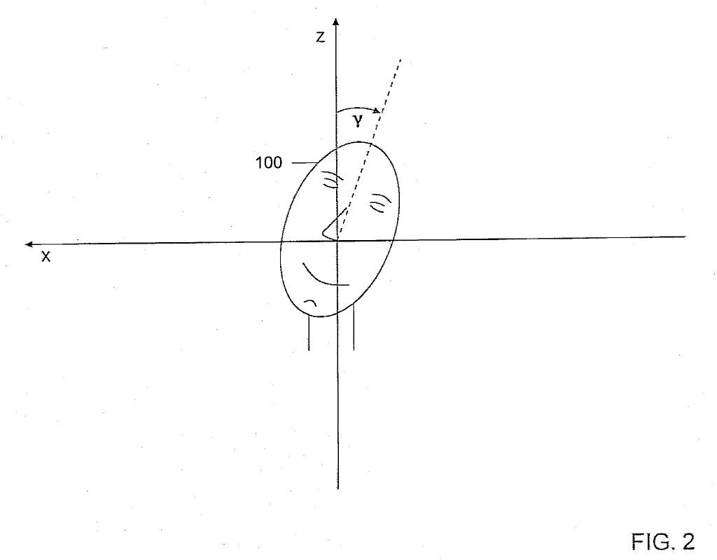

FIG. 2 is another schematic diagram that depicts the head 100 in FIG. 1 on an x-z plane to illustrate a roll angle. The roll angle characterizes a tilting of the head in the frontal plane and is indicated by a γ in FIG. 2.

Given the coordinate system described above with reference to FIGS. 1 and 2, a straight-looking head in an upright position corresponds to a yaw angle φ=0, a roll angle γ=0, and pitch angle δ=0. It should be understood that example head-tracking systems are described below with reference to the yaw angle, roll angle and pitch angle to characterize the viewing direction, or the direction in which the head is facing or the position of the head, however, these and other examples may be described with reference to other parameters. For example, the coordinates of the point where arrow A in FIG. 1 intersects a sphere with a radius of 1 centered around the head 100 may define alternative parameters.

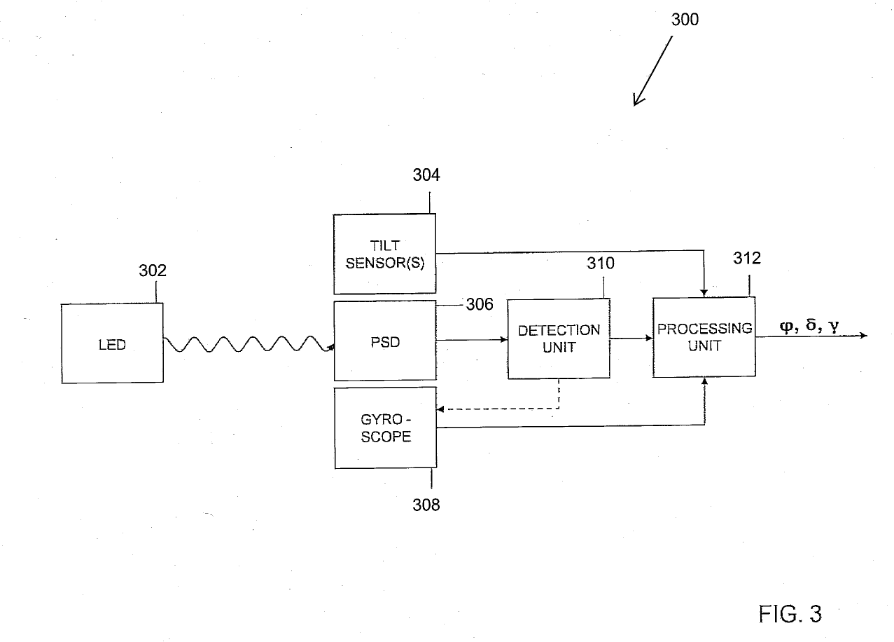

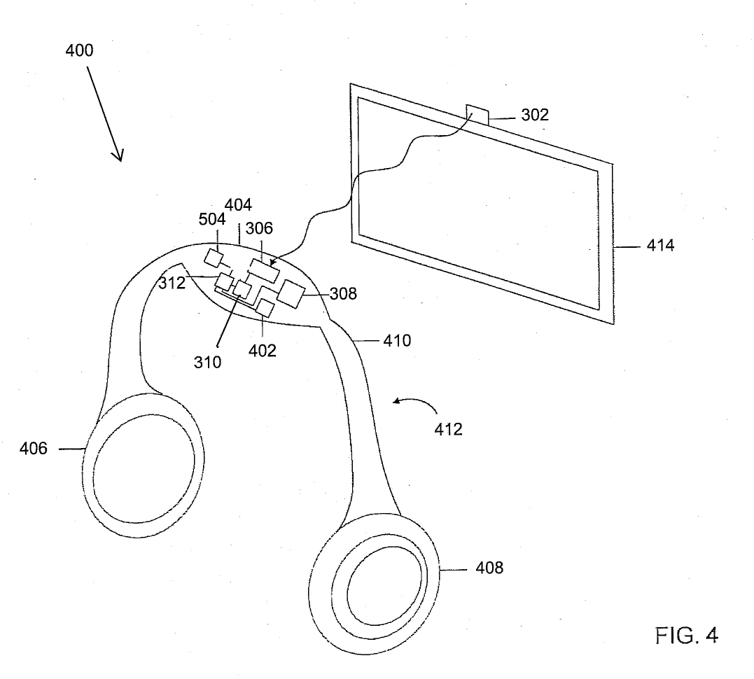

FIG. 3 is a block diagram of an example head-tracking system 300. The head-tracking system 300 may be attached on the head 100 (in FIG. 1) as described below with reference to FIG. 4. The head-tracking system 300 includes one or more tilt sensors 304 and a gyroscope 308 to determine the yaw angle, roll angle and pitch angle of the head 100 (in FIG. 1). The tilt sensors 304 and the gyroscope 308 may be implemented as a combined 3-dimensional gyroscope/inclinometer sensor, or as separate components.

The tilt sensors 304 are used to obtain the pitch angle and roll angle. Tilt sensors 304 typically operate by sensing the effect that gravity has on a movable element to determine the pitch angle and the roll angle. A single tilt sensor 304 may be used for measuring both the pitch angle and the roll angle. Alternatively, one-dimensional tilt sensors 304 may be arranged perpendicular to one another and use one to determine the pitch angle and the other to determine the roll angle, In example implementations, gravity provides a reference direction for the tilt sensors 304 precluding the need for calibration, or setting of the zero point, of these sensors 304.

The gyroscope 308 in the example shown in FIG. 3 detects the yaw angle of the head 100. The gyroscope 308 measures the angular acceleration or velocity of the head 100 in the horizontal plane. The yaw angle is determined by integration, which may be performed by processing unit 312 in the example illustrated in FIG. 3. The processing unit 312 may also be coupled to the tilt sensors 304 and is configured to calculate and output the yaw angle φ, pitch angle δ and roll angle γ.

Over time, gyroscopes may often exhibit a drift of the zero point corresponding to a yaw angle of 0°. The head-tracking system 300 shown in FIG. 3 includes a 1-dimensional or a 2-dimensional position-sensitive device (PSD) 306 that may be used to compensate for such a drift. The position-sensitive device 306 may be configured to detect light emitted by a light-emitting diode (LED) unit 302, which is attached to a stationary reference point. The stationary reference point may be located at least approximately in a forward-looking direction (which may be a direction where yaw angle, roll angle and pitch angle are approximately equal to 0). When the position-sensitive device 306 detects light from the LED unit 302, a corresponding signal is output to a detection unit 310. The detected position of the LED unit 302 provides a calibration signal for setting the zero point. For example, when the light from LED unit 302 is received at the center of the position-sensitive device 306, the detection unit 310 may decide that the head is looking exactly in a forward direction and may then send a corresponding signal to the processing unit 312 to set the temporarily detected yaw angle to 0. In another example, the yaw angle may be set to 0 if the light from the LED unit 302 is detected at any position of the position-sensitive device 306, or a calculation may be performed to obtain the zero direction from whatever position the light is detected on position-sensitive device 306. In another example, the stationary reference point at which the LED unit 302 is attached may deviate from the forward-looking direction by an amount that may be stored in the detection unit 310 and/or in the processing unit 312.

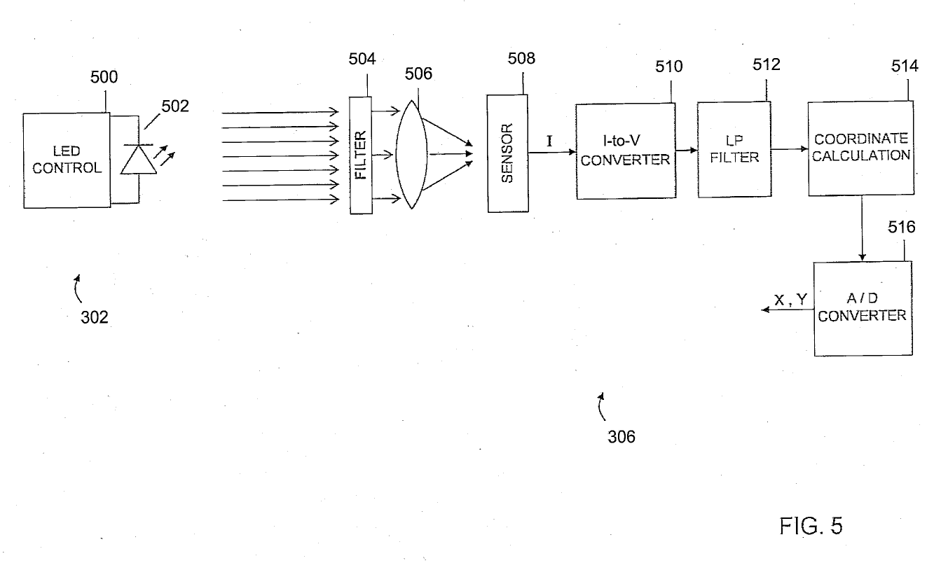

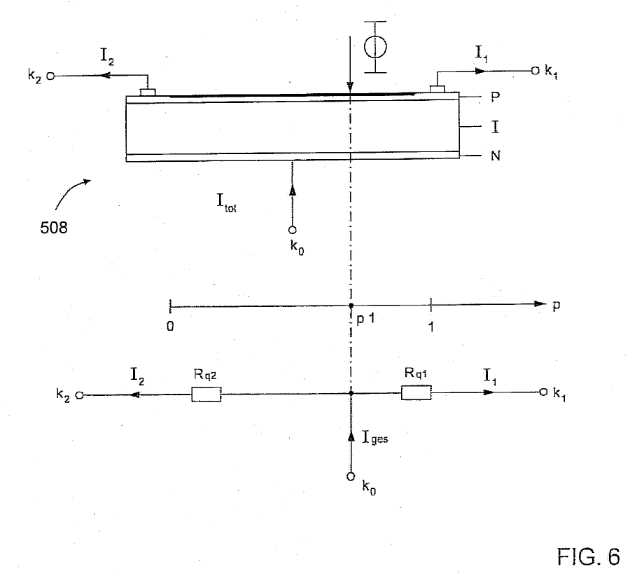

By using an extended position-sensitive device 306, a zero point may also be set if the head 100 (FIG. 1) to which the head-tracking system is attached does not exactly assume the zero position, or the forward-looking position. Such examples are described below with reference to FIGS. 5 and 6.

As described above, the detection unit 310 may send a calibration signal to the processing unit 312. The calibration signal may also be fed directly to the gyroscope 308 (indicated by the broken line in FIG. 3). The gyroscope 308 may use the calibration signal if, for example, the gyroscope 308 integrates the measured accelerations and/or velocities and outputs the yaw angle. In addition, while the tilt sensors 304 are used for determining roll and pitch angles in the example shown in FIG. 3, the gyroscopes may also be used for detecting roll and pitch angles. The calibration of the tilt sensors 304 may be performed in the same manner as for the gyroscope 308.

FIG. 4 is a perspective, schematic view of the head-tracking system in FIG. 3. A head- tracking system 400, which includes the components 304-312 discussed above with reference to FIG. 3 may be attached at a top point of a headphone or a headset 412 that includes a holder 410 and a pair of earphones 406, 408. In addition, the LED unit 302 in FIG. 4 is attached at the top of a display 414, which may be for example a flat screen display or a cathode ray tube. When a user wearing the headphone 412 faces in the direction of the display 414, the position-sensitive device 306 receives light from the LED unit 302 indicating that the user is at least approximately looking in a forward direction.

As described above, the position-sensitive device 306 may include an extended sensor area providing for the identification of a point within the sensor area that receives the light from the LED unit 302. The extended sensor area position-sensitive device 306 may permit the system to detect the light and set the zero point, at least approximately, correctly in situations when the viewing direction is not precisely in the forward direction, For example, the user may not put the headset 412 on straight, but in a slightly tilted manner. Or, the user may not look exactly in the forward direction.

As shown in FIG. 4, a transmitter 402 may be connected to the processing unit 312. The transmitter 402 may be used to transmit the detected yaw, pitch and roll angles to another device (not shown), which may use this information, The other device that receives the information may be an audio device that produces sound signals for the headset 412 and/or a video device that generates video signals for the display 414. The sound reproduced by the headset 412 and/or the picture displayed by the display 414 may be updated according to the changes in the head position detected by the head-tracking system 400.

In an example implementation, the headset 412 may be a wireless headset that receives the sound signals in a wirelessly via infrared or radio signals, for example. The transmitter 402 may, for example, be integrated in a corresponding transmission system. If the headset 412 receives sound signals via a wire, the transmitter 402 may use the wire or a dedicated wire to transmit the results obtained by the head-tracking system 400.

In some example implementations, the components of the head-tracking system 400 may be attached to the headset 412 in different positions from those shown in FIG. 4. The head-tracking system may also be used independently from a headset. For example, any other means for attaching the headset to the head of a user, such as, for example, an elastic band, may be provided. Such a headset may be used, for example, when sounds are not reproduced via a headset as shown in FIG. 4, but rather by wired loudspeakers.

In other example implementations, a stationary display such as the display 414 in FIG. 4 may be attached to headset 412. The LED unit 302 may then be attached to a wall, for example, to provide a stationary reference point.

As shown in FIGS. 3 and 4, the position information obtained via the position-sensitive device 306 may be used to calibrate the gyroscope 308. Alternatively, or additionally, the position information may be used directly to obtain the pitch angle, the roll angle and/or the yaw angle. In this alternative example, the sensor(s) 304, 308 may be omitted.

Further modifications are possible in other example implementations. For example, the tilt sensors 304 may be omitted if the head-tracking device only detects the yaw angle. In addition, the detection unit 310 and the processing unit 312 may be implemented both as separate units and as a single processing unit using, for example, a microprocessor.

Example implementations of the position-sensitive device 306 and the LED unit 302 are described below with reference to FIGS. 5 and 6.

FIG. 5 is a block diagram of an example of the position-sensitive device 306 used in the example head-tracking system 300 of FIG. 3. As shown in FIG. 5, the LED unit 302 includes a LED control 500 and a light-emitting diode 502. In one example, the light-emitting diode 502 may be an infrared diode such that the light emitted by the light-emitting diode 502 does not disturb the user of the head-tracking system. In other examples, the light-emitting diodes may emit visible light. In still other examples, light emitting devices other than LEDs may be used.

In an example implementation, the LED control 500 is a power supply that supplies the light-emitting diode (LED) 502 with power. In another example, the LED control 500 includes a modulation circuit for modulating the light emitted by the LED 502 according to a predetermined pattern. The modulation of the light emitted by the LED 502 distinguishes the light emitted from the LED 502 from light emitted from other sources.

As shown in FIG. 5, the position-sensitive device 306 includes an optical filter 504 for filtering the light received. If the LED 502 is an infrared LED, the optical filter 504 may be, for example, a filter that is transparent to infrared light, but opaque to light of other wavelengths, such as visible light. The optical filter 504 may also be fine-tuned to be wavelength selective and only pass the light having the specific wavelength of the light emitted by the LED 502.

The optical filter 504 shown in FIG. 5 may pass light to an optical system 506 that may include one or more lenses for focusing the light received and filtered on a sensor 508. In one example, the center of gravity of the focused light beam on the sensor 508 may be identified as the position of the light beam. Operation of an example sensor 508 is described below with reference to FIG. 6.

FIG. 6 is a schematic diagram illustrating operation of a sensor of an example of a position-sensitive device used in the head-tracking system in FIG. 3. FIG. 6 shows a cross-sectional view of the sensor 508. The sensor 508 includes an extending pin structure, which includes a p-doped semiconductor layer p, a nominally undoped or low-doped (or insulating) semiconductor layer i, and an n-doped semiconductor layer n. A back contact k₀ is connected to the n-doped layer n of the pin structure at approximately the middle of the n layer. The contacts k₁ and k₂ connect to the p-doped layer p on opposing sides. In order to provide two-dimensional sensing, additional contacts (not shown) may be provided in a direction perpendicular to the one shown.

The device shown in FIG. 6 uses a lateral photo-effect for sensing position. A total current Iₜₒₜ is input at the contact k₀. An arrow labeled Φ indicates a position where light may fall on the sensor 508. The device becomes conducting in the area in which light falls on the sensor 508 in a transverse direction (the up-down direction in FIG. 6). This location is shown at the location designated p₁ in the p-axis in the middle of FIG. 6. If the resistance of the n-doped layer is low, the position p₁ where light falls on the sensor 508 may determine the resistance from k₀ to k₁ (indicated as R_{q1} and R_{q2}, respectively, as shown in the lower part of FIG. 6). For example, the total resistance between k₁ and k₂ may be R_{q1} and R_{q2}, and the resistance R_{q1} relative to R_{q2} may depend on the where the position p₁ falls on the p-axis between the positions 0 and 1, which correspond to the position of the contacts, k₁ and k₂. Therefore, the currents I₁ and I₂ detected at the contacts k₁ and k₂, respectively, are indicative of the position p₁ relative to the position of the contacts, k₁ and k₂. In the dimension shown in FIG. 6, the position p₁ relative to the middle of the sensor is proportional to (I₁−I₂)/(I₁+I₂).

A two-dimensional sensor may be implemented and used similar to the one-dimensional sensor 508 described above.

In position-sensitive devices such as the one illustrated in FIG. 6, the above-given ratio of currents does not depend on the light intensity received by the sensor 508. Therefore, the distance of the position-sensitive device from the LED 502 does not in general affect the results.

Referring to FIG. 5, the currents (for example current I₁, I₂ explained with reference to FIG. 6) output by the sensor 508 are supplied to a current-to-voltage converter 510, which converts the current into voltages. The conversion may be obtained by measuring the voltage drop of a resistor having a known resistance through which the respective current flows. The generated voltages are then filtered by a low-pass filter 512 to reduce noise followed by an analog coordinate calculation unit 514, which calculates the coordinates of the light received on the sensor 508 based on the above-mentioned current ratios. If the LED control 500 modulates the light as described above, the coordinate calculation unit 514 may also perform a corresponding demodulation such that only light actually received from LED 502 is used. The coordinate calculation unit 514 in FIG. 5 is connected to an analog-to-digital converter 516, which converts the calculated coordinates to digital values X, Y indicating the position of the light received on the sensor 508.

It is to be understood that the position sensing device 306 illustrated in FIG. 5 is only an example, and modifications or alternatives are possible. For example, while in the position-sensing device 306 illustrated in FIG. 5, the analog-to-digital converter 516 is positioned downstream of the coordinate calculation unit 514, the analog-to-digital converter 516 may also be positioned between the current-to-voltage converter 510 and the low-pass filter 512. In this alternative example, the low-pass filter 512 would be a digital filter and the coordinate calculation unit 514 would be a digital calculation unit (which may include a demodulation unit). The analog-to-digital converter 516 may also be positioned between the low-pass filter 512 and the coordinate calculation 514. Other example implementations may not use an analog-to-digital-converter, and analog signals are output to be processed by detection unit 310 of FIG. 3. In other examples, a band-pass filter is used instead of the low-pass filter 512. Other example implementations may include an electrical filter, either in addition to or instead of the optical filter 504. The electrical filter may be arranged upstream or downstream of the current-to-voltage converter 510. Such an electrical filter may be an active filter or a passive filter, a single filter, a cascaded filter system or any other suitable filter.

In addition, examples of the sensor 508 described above include a two-dimensional position-sensitive device based on a pin diode. However, other types of sensors may be used. For example, a one-dimensional position-sensitive device, which determines the position only in one direction may be utilized. Also, instead of using a pin structure, other types of light-detecting devices such as an array of charge-coupled devices (CCD) or CMOS devices similar to those used in digital cameras may be used. The elements of such an array are called pixels, and position information may be obtained based on which pixels are illuminated. When using such a camera-type sensor, a different kind of marker, such as for example a cross, may be used, which is then recognized by a picture recognition algorithm.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for operating a head-tracking system comprising:
detecting a stationary reference point; and
determining a position of a head equipped with the head-tracking system based on the detected stationary reference point.

2. The method of claim 1 where the determined position is a reference position, the method further comprising:
calibrating a detector for detecting a position of the head based on the reference position.

3. The method of claim 2 where the calibrating step includes setting a zero point of the detector.

4. The method of claim 2 where the detecting of the stationary reference point is performed without using the detector.

5. The method of claim 1 where the detecting step includes determining a position where light from the reference point reaches the head-tracking system.

6. The method of claim 1 further comprising:
emitting light from the reference point, where the detecting step includes detecting the emitted light.

7. The method of claim 6 where the emitting includes modulating the emitted light according to a predetermined pattern.

8. The method of claim 1 where the determined position includes information indicative of a direction the head is facing.

9. A head-tracking system comprising:
a first detector for detecting a stationary reference point; and
a device for determining a position of a head equipped with the head-tracking system based on the detected reference point.

10. The head-tracking system of claim 9 where the device for determining the position of the head is adapted to determine a reference position of the head, the head-tracking system further comprising:
a second detector for detecting a position of the head; and
a calibrator for calibrating the second detector based on the reference position.

11. The head-tracking system of claim 10 where the second detector includes a gyroscope, where the calibrator is adapted for setting a zero point of the gyroscope.

12. The head-tracking system of claim 10 where the second detector includes at least one tilt sensor.

13. The head-tracking system of claim 9 where the first detector includes a position-sensitive device.

14. The head-tracking system of claim 13 where the position-sensitive device includes a pin diode.

15. The head-tracking system of claim 13 where the position-sensitive device includes at least one array from the group consisting of a CCD array and a CMOS array.

16. The head-tracking system of claim 9 further comprising a headset, where the first detector is attached to the headset.

17. The head-tracking system of claim 9 further comprising a light emitter to be attached to the stationary reference point.

18. The head-tracking system of claim 17 where the light emitter includes a light-emitting diode.

19. The head-tracking system of claim 17 where the light emitter is configured to emit light in the infrared spectrum.

20. The head-tracking system of claim 17 where the light emitter includes a modulation circuit for modulating light emitted by the emitter.

21. The head-tracking system of claim 18 where the position determined by the device for determining the position of the head includes information indicative of a direction the head is facing.

22. A head-tracking system comprising:
a detector configured to detect a stationary reference point,
a sensor configured to detect a position of a head equipped with the head-tracking system, and
a calibration circuit configured to calibrate the sensor based on a signal received from the detector.
